(19) United States
(12) Patent Application Publication
(10) Pub. No.: US 2012/0167023 A1
(43) Pub. Date: Jun. 28, 2012

(54) METHOD FOR SYNTHESIZING TILE INTERCONNECTION STRUCTURE OF FIELD PROGRAMMABLE GATE ARRAY

(75) Inventor: Young Hwan BAE, Daejeon (KR)

(73) Assignee: Electronics and Telecommunications Research Institute, Daejeon (KR)

(21) Appl. No.: 13/310,580

(22) Filed: Dec. 2, 2011

(30) Foreign Application Priority Data
Dec. 23, 2010 (KR) 10-2010-0134106

(51) Int. Cl. G06F 17/50

(52) U.S. Cl. 716/104

(57) ABSTRACT

A method for synthesizing a tile interconnection structure of a field programmable gate array (FPGA) includes: receiving an interconnection structure specification of the FPGA; constructing a tile interconnection graph based on the interconnection structure specification; converting the interconnection structure specification into a connection diagram between two points on the tile interconnection graph; searching for a shortest path for connection requirements between two points from the connection diagram between two points, and building a bundle structure; and synthesizing a tile interconnection structure from the bundle structure.

### CROSS-REFERENCES TO RELATED APPLICATIONS

The present application claims priority under 35 U.S.C 119(a) to Korean Application No. 10-2010-0134106, filed on Dec. 23, 2010 in the Korean intellectual property Office, which is incorporated herein by reference in its entirety set forth in full.

### BACKGROUND

Exemplary embodiments of the present invention relate to a method for synthesizing a tile interconnection structure of a field programmable gate array (FPGA), and more particularly, to a method for synthesizing a tile interconnection structure of an FPGA, which receives the coupling relation of an interconnection structure to construct an FPGA tile and synthesizes the FPGA tile such that the interconnection structure of the FPGA is automatically built.

Generally, in an FPGA, switch elements coupled between various metal lines which are already implemented over a chip are programmed to form a coupling relation, in order to interconnect logic elements. In the case of an SRAM-type FPGA, since one switch element is implemented as an n-type transistor, a pass transistor, or a multiplexer, the switch element causes a large signal delay time. In order to make up for the signal delay time, various types of lines are provided.

FIG. 1 is a schematic view of a hierarchical interconnection structure of an FPGA. FIG. 2 is a schematic view of a horizontal double line of the FPGA. FIG. 3 is a schematic view of a tile structure for the horizontal double line of the FPGA. FIG. 4 is a schematic view of tile structures for the horizontal double line of the FPGA which are horizontally coupled. FIG. 5 is a schematic view of a mixed line structure in which vertical/horizontal lines of the FPGA are mixed. FIG. 6 is a schematic view of a tile structure for the mixed line structure of FIG. 5. FIG. 7 is a schematic view of a matrix-shaped tile structure in which the tile structures of FIG. 6 are repetitively formed.

Referring to FIG. 1, single lines, double lines, and sextet lines may be provided. A single line refers to a line which is directly coupled from one logic block to an adjacent logic block around the one logic block, and a double line refers to a line which is directly coupled to a logic block existing within a two-block distance in the four directions thereof. A sextet line refers to a line which is directly coupled to a logic block existing within a six-block distance in the four directions thereof, and a connectable terminal may be provided in a third logic block.

In the FPGA, logic blocks capable of implementing logic and tile blocks, including a programmable interconnection structure, are repetitively arranged in X/Y directions by a desired capacity, thereby implementing FPGA fabric. That is, when a double line is implemented as shown in FIG. 2, a tile block should be designed as shown in FIG. 3, in order to design a desired interconnection structure by a simple repetition and without correction of the tile.

It is very difficult to design the interconnection structure of a tile such that the interconnection structures having various lengths and forms over an FPGA board can be implemented by repeating one tile, and the design operation requires a lot of time. When the operation is automated, it may contribute to reducing design cost and improving the performance of an FPGA chip.

The above-described technology is a related art of the technical field to which the present invention pertains, and does not indicate prior art.

In a recent FPGA, however, the function and capacity of logic blocks have been enhanced to increase the efficiency of the logic blocks and reduce a line delay time, and a variety of interconnection layers are supported. Furthermore, the FPGA supports a mixed and complicated line type, as shown in FIG. 5.

In particular, it is difficult for a designer to manually design the tile structure as shown in FIG. 3 or 6 or the interconnection structure of the FPGA as shown in FIG. 4 or 7.

Therefore, there is demand for a design tool capable of automatically designing a tile block, which is becoming increasingly complicated.

### SUMMARY

An embodiment of the present invention relates to a method for synthesizing a tile interconnection structure of an FPGA, which receives a coupling relation of an interconnection structure to construct an FPGA tile and synthesizes the FPGA tile such that the interconnection structure of an FPGA is automatically built.

In one embodiment, a method for synthesizing a tile interconnection structure of an FPGA includes: receiving an interconnection structure specification of the FPGA; constructing a tile interconnection graph based on the interconnection structure specification; converting the interconnection structure specification into a connection diagram between two points on the tile interconnection graph; searching for a shortest path for connection requirements between two points from the connection diagram between two points, and building a bundle structure; and synthesizing a tile interconnection structure from the bundle structure.

The converting of the interconnection structure specification may include acquiring a minimum spanning tree from the connection requirements of the interconnection structure specification.

The converting of the interconnection structure specification may include constructing a complete graph of the connection requirements of the interconnection structure specification, and the minimum spanning tree is acquired from the complete graph.

The tile interconnection graph may be constructed by receiving the interconnection structure specification in a connection diagram form between ports.

The method may further include a step before the constructing of the tile interconnection graph determining whether the interconnection structure specification is a mixed bundle interconnection structure or not. When it is determined that the interconnection structure specification is a mixed bundle interconnection structure, the tile interconnection graph may be constructed.

The synthesizing of the tile interconnection structure may be performed by a simple bundle interconnection structure unit.

The tile interconnection graph may include four ports disposed on respective surfaces of a switch box within each tile and four interconnection tracks connected to the four ports.

### BRIEF DESCRIPTION OF THE DRAWINGS

The above aspects, features and other advantages will be more clearly understood from the detailed description taken in conjunction with the following drawings, in which:

FIG. 1 is a schematic view of a hierarchical interconnection structure of an FPGA;

FIG. 2 is a schematic view of a horizontal double line of the FPGA;

FIG. 3 is a schematic view of a tile structure for the horizontal double line of the FPGA;

FIG. 4 is a schematic view of tile structures for the horizontal double line of the FPGA which are horizontally coupled;

FIG. 5 is a schematic view of a mixed line structure in which vertical/horizontal lines of the FPGA are mixed;

FIG. 6 is a schematic view of a tile structure for the mixed line structure of FIG. 5;

FIG. 7 is a schematic view of a matrix-shaped tile structure in which the tile structures of FIG. 6 are repetitively placed;

FIG. 8 is a schematic view of the structure of an FPGA tile in a method for synthesizing a tile interconnection structure of an FPGA in accordance with an embodiment of the present invention;

FIG. 9 is a flow chart showing a method for automatically building an interconnection structure of an FPGA tile block in accordance with the embodiment of the present invention;

FIG. 10 is a schematic view of the structure of a horizontal double line for the method in synthesizing a tile interconnection structure of an FPGA in accordance with the embodiment of the present invention;

FIG. 11 is a schematic view of a bundle structure for the horizontal double line for the method in synthesizing a tile interconnection structure of an FPGA in accordance with the embodiment of the present invention.

FIGS. 12A to 12C are schematic views showing a method for synthesizing a horizontal double line bundle for the method in synthesizing a tile interconnection structure of an FPGA in accordance with the embodiment of the present invention;

FIG. 13 is a schematic view of the structure of a horizontal sextet line for the method in synthesizing a tile interconnection structure of an FPGA in accordance with the embodiment of the present invention;

FIG. 14 schematically illustrates a result obtained by synthesizing the horizontal sextet line for the method in synthesizing a tile interconnection structure of an FPGA in accordance with the embodiment of the present invention;

FIG. 15 is a schematic view of a tile structure in which horizontal sextet lines are repeated for the method in synthesizing a tile interconnection structure of an FPGA in accordance with the embodiment of the present invention;

FIG. 16 is a schematic view of the interconnection structure of a tile including various horizontal/vertical bundles for the method in synthesizing a tile interconnection structure of an FPGA in accordance with the embodiment of the present invention;

FIG. 17 is a schematic view of a tile including double lines positioned in the four directions for the method in synthesizing a tile interconnection structure of an FPGA in accordance with the embodiment of the present invention;

FIG. 18 is a schematic view of a tile interconnection model for the method in synthesizing a tile interconnection structure of an FPGA in accordance with the embodiment of the present invention;

FIG. 19 schematically illustrates a connection diagram between a tile interconnection graph and an interconnection graph;

FIGS. 20A and 20B are schematic views showing a conversion process into a connection requirement between two points using a minimum spanning tree for the method in synthesizing a tile interconnection structure of an FPGA in accordance with the embodiment of the present invention;

FIG. 21 schematically illustrates a tile interconnection graph where a search region is proposed as a bounding box and a connection diagram between two points of the interconnection structure for the method in synthesizing a tile interconnection structure of an FPGA in accordance with the embodiment of the present invention;

FIG. 22 schematically illustrates a result obtained by searching for the shortest path on the tile interconnection graph for the method in synthesizing a tile interconnection structure of an FPGA in accordance with the embodiment of the present invention;

FIG. 23 schematically illustrates a bundle structure extracted from the shortest path for the method in synthesizing a tile interconnection structure of an FPGA in accordance with the embodiment of the present invention;

FIG. 24 schematically illustrates a process of positioning a bundle structure in the tile for the method in synthesizing a tile interconnection structure of an FPGA in accordance with the embodiment of the present invention;

FIG. 25 schematically illustrates a finally-synthesized tile interconnection structure; and

FIG. 26 schematically illustrates an example in which the tile of FIG. 25 is arranged in a 3×3 matrix.

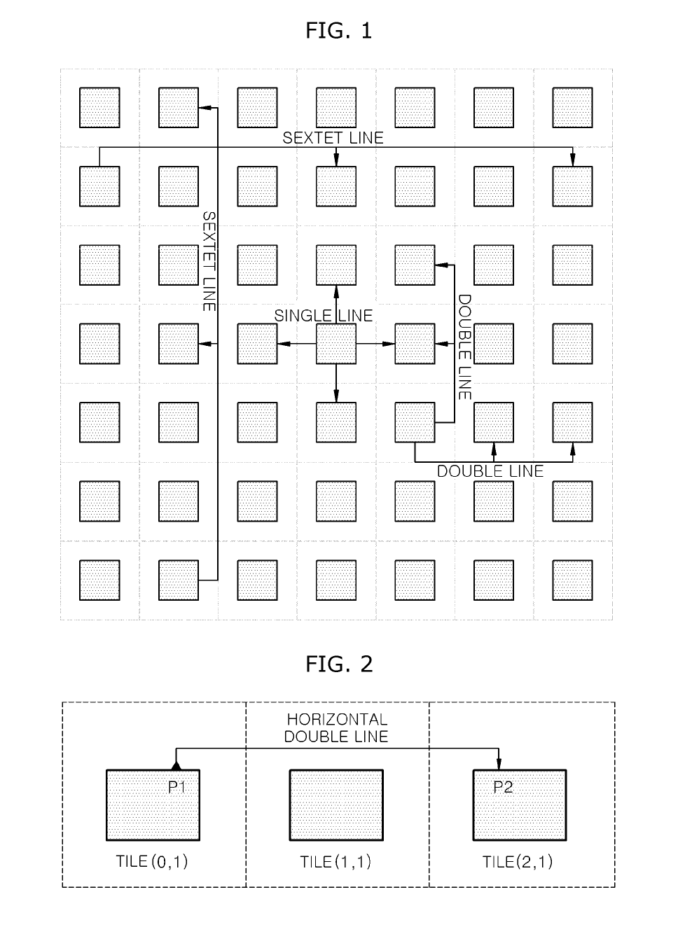

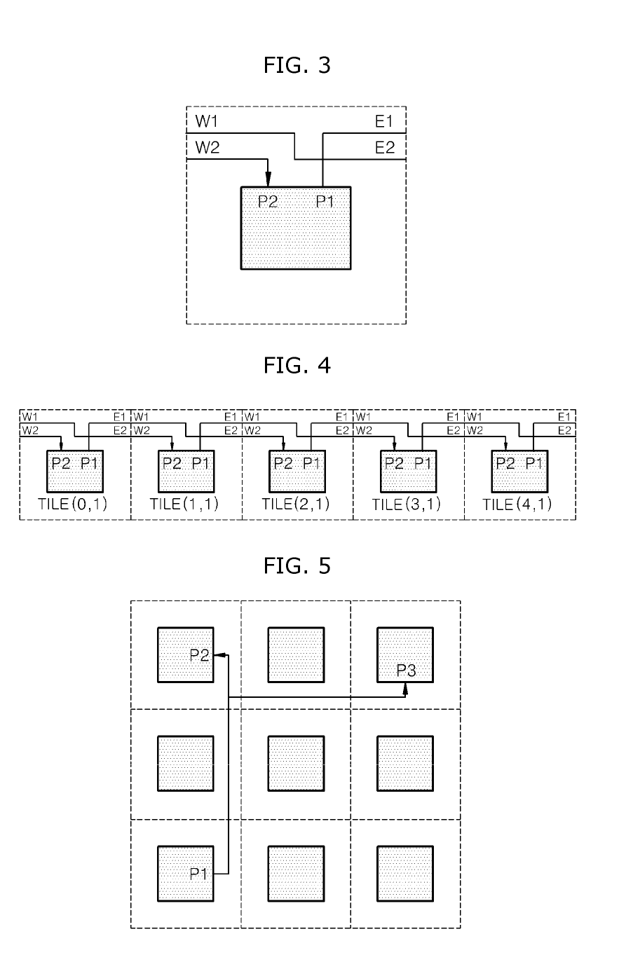

### DESCRIPTION OF SPECIFIC EMBODIMENTS

Hereinafter, a method for synthesizing a tile interconnection structure of an FPGA in accordance with an embodiment of the present invention will be described with reference to accompanying drawings. The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms are based on the descriptions of the entire present specification.

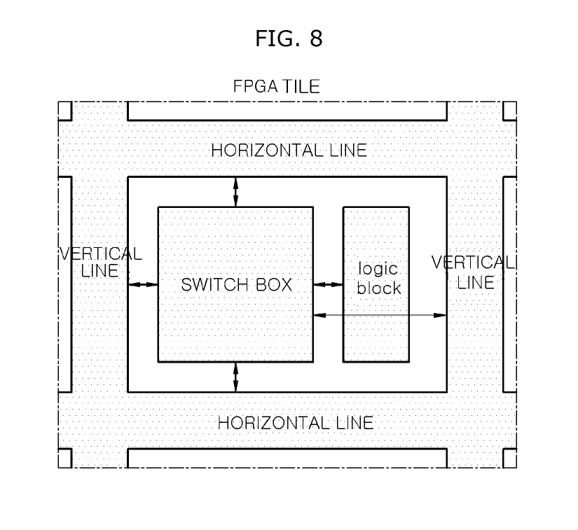

FIG. 8 is a schematic view of the structure of an FPGA tile in a method for synthesizing a tile interconnection structure of an FPGA in accordance with an embodiment of the present invention.

Referring to FIG. 8, a configurable logic block tile in an FPGA board in accordance with the embodiment of the present invention may include a switch box, a logic block, and an interconnection structure.

The logic block is where circuit logic may be implemented, and includes a memory called a lookup table, a multiplexer, a flip-flop and so on, in the case of an SRAM-type FPGA.

Metal lines are implemented between switch boxes, in order to link logic blocks. The switches inside the switch boxes are programmed outside to implement a desired coupling relation. The metal lines between the switch boxes may include horizontal lines and vertical lines. The horizontal lines are positioned over and under the switch box, and the vertical lines are positioned in the right and left sides of the switch box.

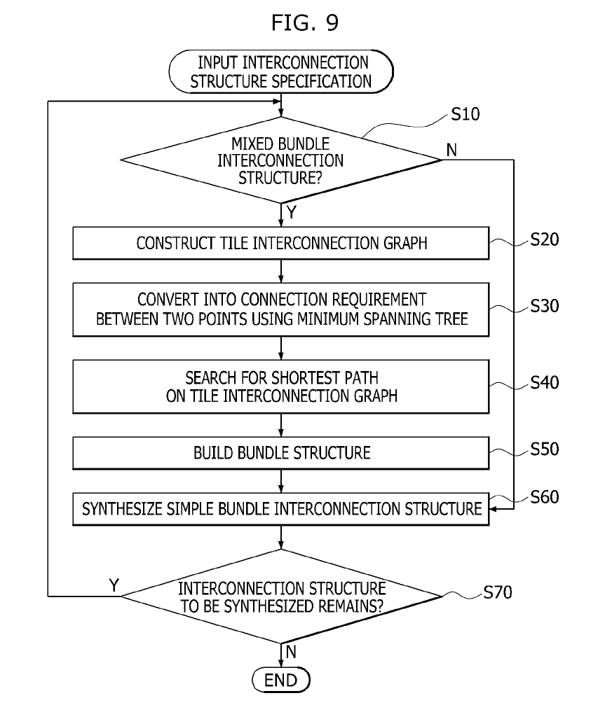

FIG. 9 is a flow chart showing a method for automatically building an interconnection structure of an FPGA tile block in accordance with the embodiment of the present invention.

Referring to FIG. 9, the respective steps of the method for automatically building an interconnection structure will be described in detail. First, an interconnection structure specification is received, and whether the specification is a simple bundle interconnection structure or mixed bundle interconnection structure is determined at step S10.

Hereinafter, an operation of synthesizing a simple bundle interconnection structure at step S70 and an operation of synthesizing a mixed bundle interconnection structure will be separately described.

Synthesizing Simple Bundle Interconnection Structure

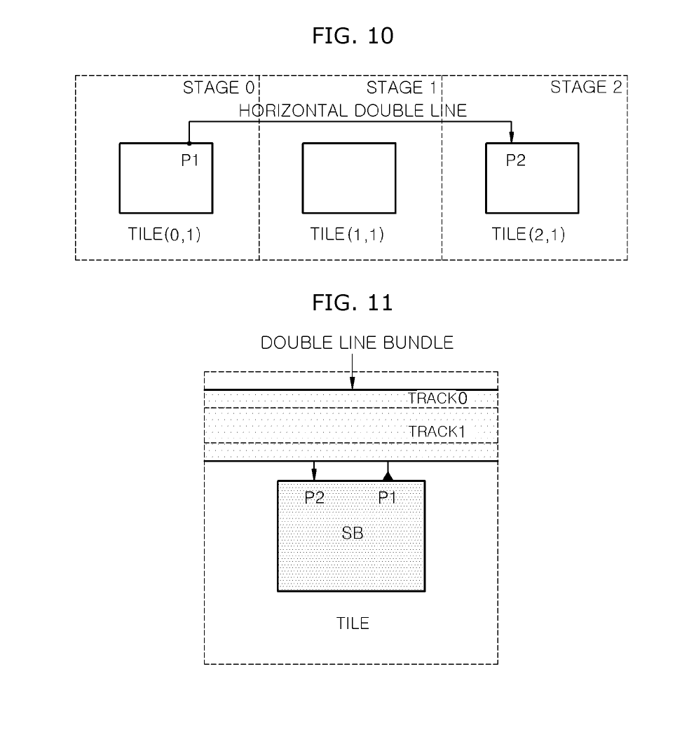

A horizontal double line as illustrated in FIG. 10 is connected only in a horizontal direction, and corresponds to a simple bundle interconnection structure. Such a simple bundle interconnection structure may be expressed as one bundle as illustrated in FIG. 11. In FIG. 10, the double line originating from a port P1 of a tile (0, 1) is connected to a port P2 of a tile (2, 1) through a tile (1, 1).

In the case of the horizontal line, a stage number of 0 is allocated to the leftmost tile, and in the case of the vertical line, the stage number of 0 is allocated to the lowermost tile. Then, the stage number is increased toward the right side (upper side). Therefore, a stage number of 1 is allocated to the tile (1, 1), and a stage number of 2 is allocated to the tile (2, 1). In the case of the double line of FIG. 10, the number of stages is 3. Line tracks corresponding to the number of stages are allocated to a bundle for implementing the double line. In this case, two line tracks are allocated.

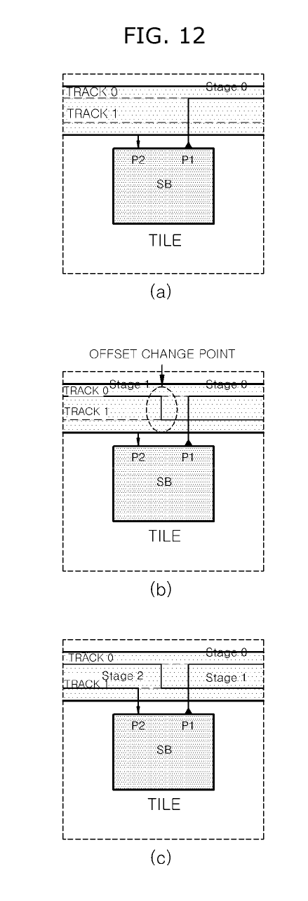

FIGS. 12A to 12C are schematic views showing a method for synthesizing a horizontal double line bundle for the method in synthesizing a tile interconnection structure of an FPGA in accordance with the embodiment of the present invention.

Referring to FIGS. 12A to 12C, a horizontal double line requirement is implemented in the tracks allocated to the double line bundle according to the order of the respective stages. Referring to FIG. 12A, a track 0 is connected to the port P1 to implement a stage 0. Referring to FIG. 12B, an interconnection line originating from track 0 and changing into a track 1 at an offset change point is connected to implement a stage 1. Referring to FIG. 12C, the track 1 and a port P2 are connected to implement a stage 2.

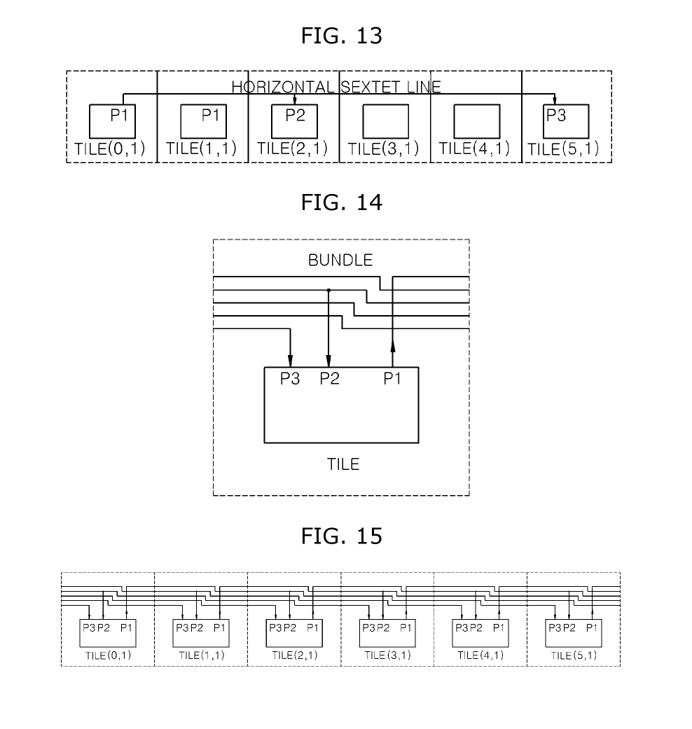

In the case of a horizontal sextet line as illustrated in FIG. 13, a port P1 of a tile (0, 1), a port P2 of a tile (2, 1), and a port P3 of a tile (5, 1) are connected. When the tiles are synthesized by the above-described method, a structure as illustrated in FIG. 14 may be built. When six structures are connected in the horizontal direction, a horizontal sextet line may be implemented as illustrated in FIG. 15.

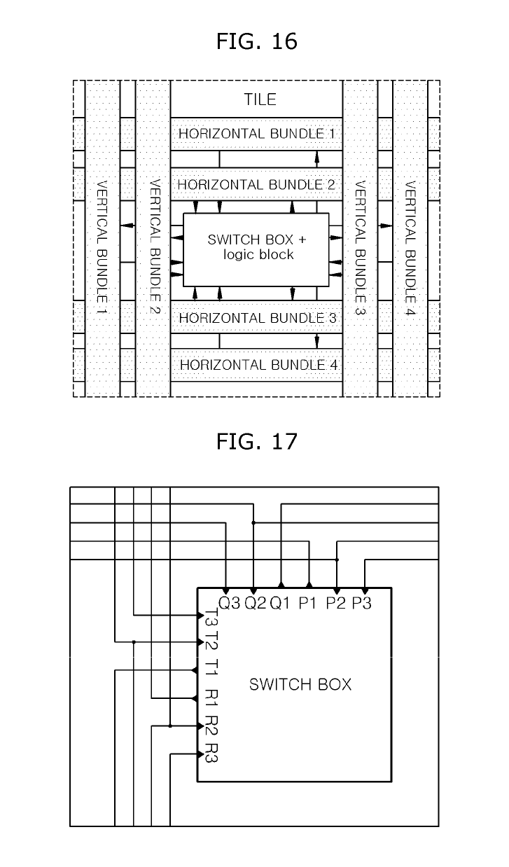

The FPGA board may include various types of bundles for implementing various types of lines, and a necessary number of tracks are allocated to the respective bundles as illustrated in FIG. 16, thereby synthesizing the interconnection structure as described above. In FIG. 16, the number of tracks and the number of bundles are only an example, and do not limit the scope of the embodiment of the present invention. For example, FIG. 17 illustrates a tile including double lines in the four directions thereof for the method in synthesizing a tile interconnection structure of an FPGA in accordance with the embodiment of the present invention.

Synthesizing Mixed Bundle Interconnection Structure

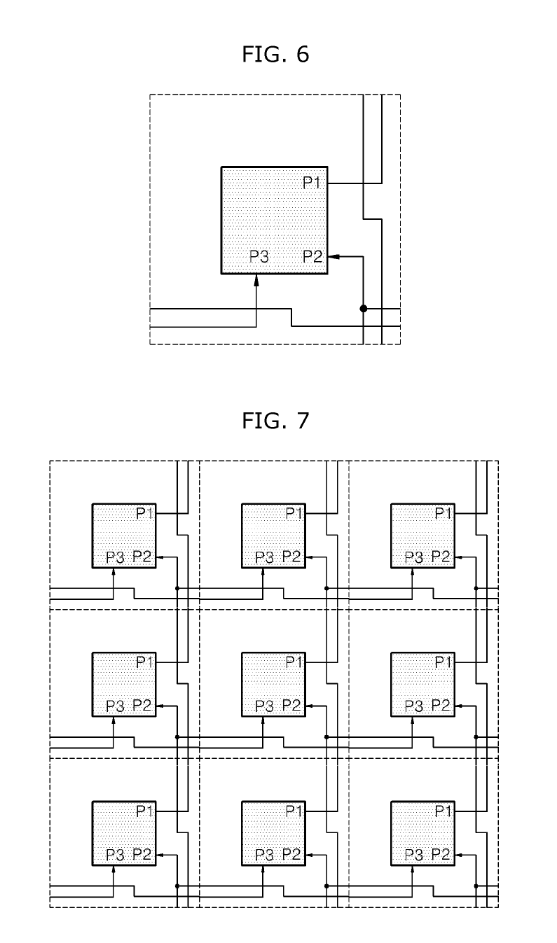

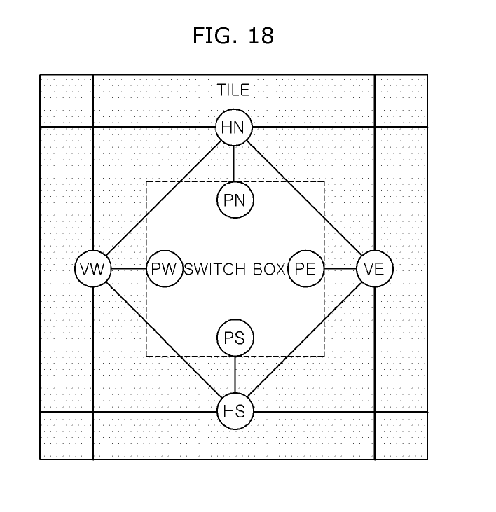

In the case of the mixed interconnection structure in which horizontal/vertical lines are mixed as illustrated in FIG. 6, it is impossible to implement the mixed interconnection structure using one simple bundle interconnection structure. Therefore, the simple bundle interconnection structure should be changed into a plurality of bundle structures connected to each other. For this structure, a tile interconnection graph may be constructed at step S20. For example, referring to FIG. 18, a tile interconnection model expressed in a graph shape by simplifying components required for synthesizing an interconnection structure within one tile may be used to construct a tile interconnection graph.

In the tile interconnection model, circles represent vertexes indicating interconnection components such as line tracks and ports, and an edge indicates a connection relation between the respective interconnection components. The respective vertexes have names allocated thereto, and the meanings of the names may be described as follows.

Here, four ports PN, PS, PW, and PE are disposed on the respective surfaces of the switch box, and four interconnection tracks HN, HS, VW, and VE are disposed to be connected to the above-described four ports PN, PS, PW, and PE.
PN: all ports positioned in the north direction of the switch box
PS: all ports positioned in the south direction of the switch box
PW: all ports positioned in the west direction of the switch box
PE: all ports positioned in the east direction of the switch box
HN: horizontal line tracks allocated to the north side of the switch box
HS: horizontal line tracks allocated to the south side of the switch box
VW: vertical line tracks allocated to the west side of the switch box
VE: vertical line tracks allocated to the east side of the switch box

An example in which such a tile interconnection model is used to synthesize the interconnection structure as illustrated in FIG. 6 will be described as follows.

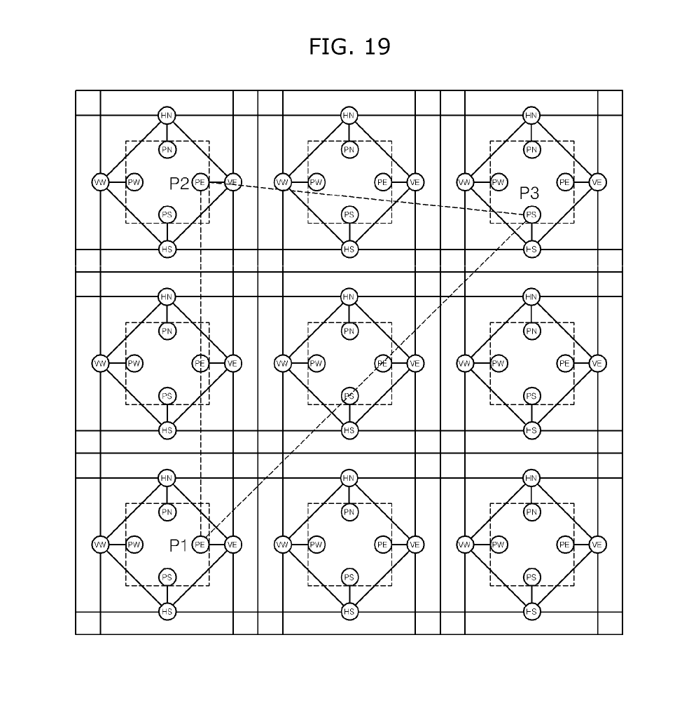

The information expressed as a connection requirement of ports of a specific switch box in the tile arrangement as illustrated in FIG. 6 is received as the specification of an interconnection structure which is to be synthesized. FIG. 19 illustrates an example in which a line connection requirement is expressed on the tile interconnection graph constructed by using the above-described tile interconnection model. The tile interconnection graph is a graph constructed by attaching a necessary number of tile interconnection models for the technology of interconnection structure in a two-dimensional arrangement.

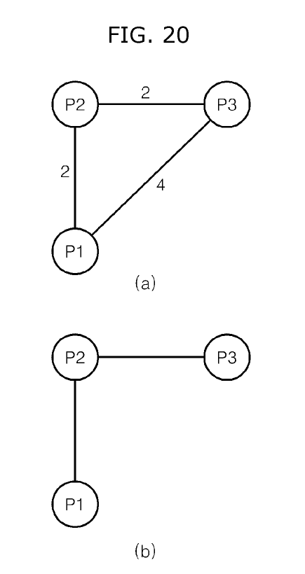

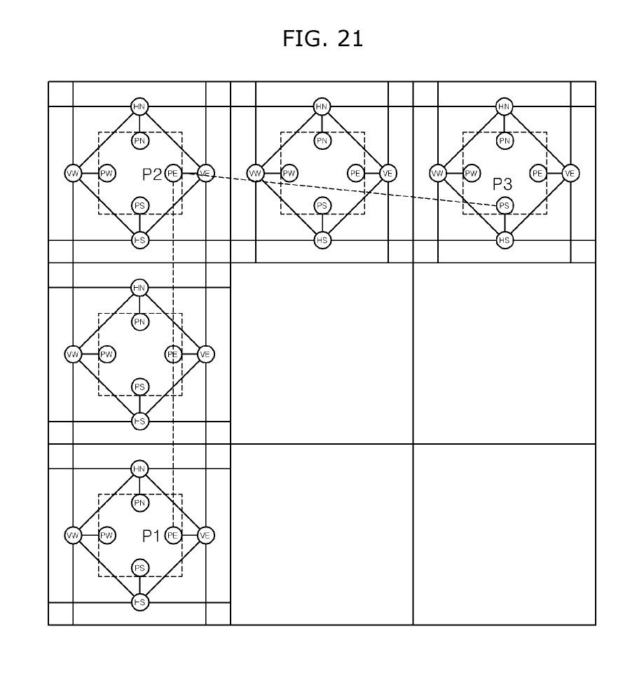

FIGS. 20A and 20B are schematic views showing a conversion process into a connection requirement between two points using a minimum spanning tree for the method in synthesizing a tile interconnection structure of an FPGA in accordance with the embodiment of the present invention.

Referring to FIG. 20A, a complete graph in which ports P1, P2, and P3 having connection requirements are set to vertexes and a Manhattan distance between the ports at an edge therebetween is set to a weight constructed to implement an interconnection structure built from a connection requirement on the tile interconnection graph using a minimum number of interconnection tracks. Subsequently, referring to FIG. 20B, a minimum spanning tree is obtained from the complete graph and converted into a plurality of connection requirements between two points, at step S30.

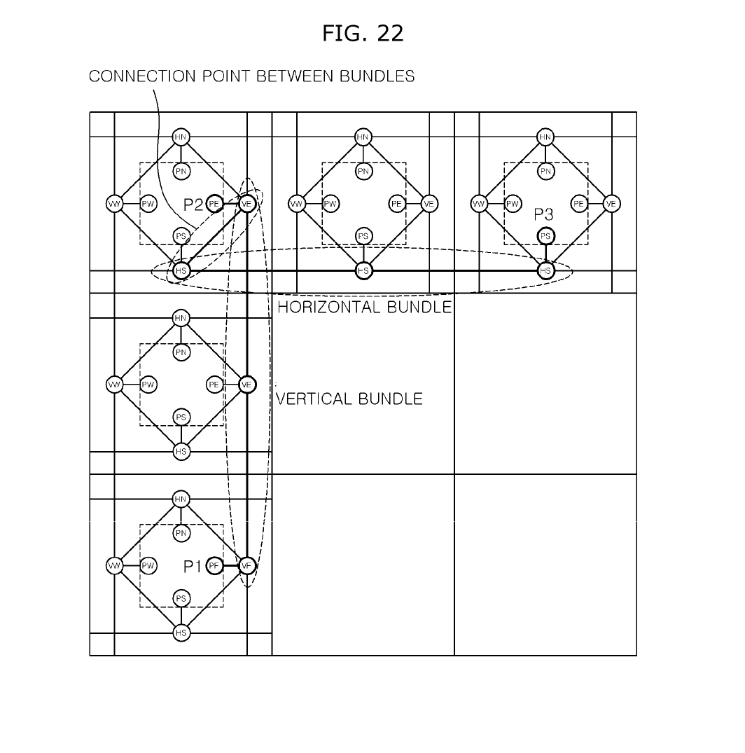

FIG. 21 illustrates a result obtained by removing regions other than bounding boxes of the respective connection requirements between two points from the tile interconnection graph of FIG. 19. In the tile interconnection graph of FIG. 21, the shortest path between the connection requirements between two points may be obtained by applying a graph shortest path algorithm. Then, the shortest path as illustrated in FIG. 22 may be obtained.

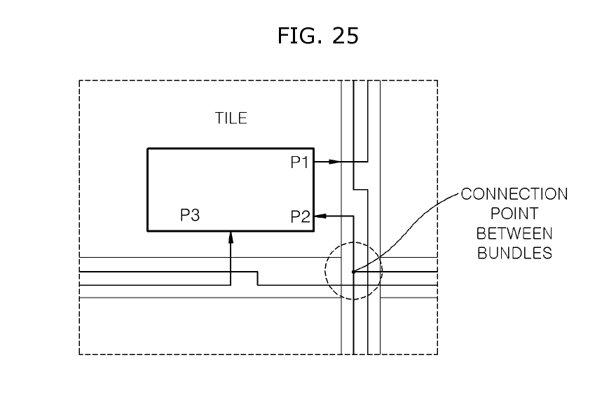

Among the vertexes related to the line tracks HN, HS, VW, and VE existing on the shortest path, vertexes where the same types continue may be partitioned and then constructed as bundles. Then, it is possible to build a vertical bundle and a horizontal bundle as illustrated in FIG. 22, at step S50. The coordinates of the two bundles are controlled in such a manner that the line tracks are connected when connection points between the bundles of FIG. 22 are extracted and the line tracks are allocated to each bundle as illustrated in FIG. 25.

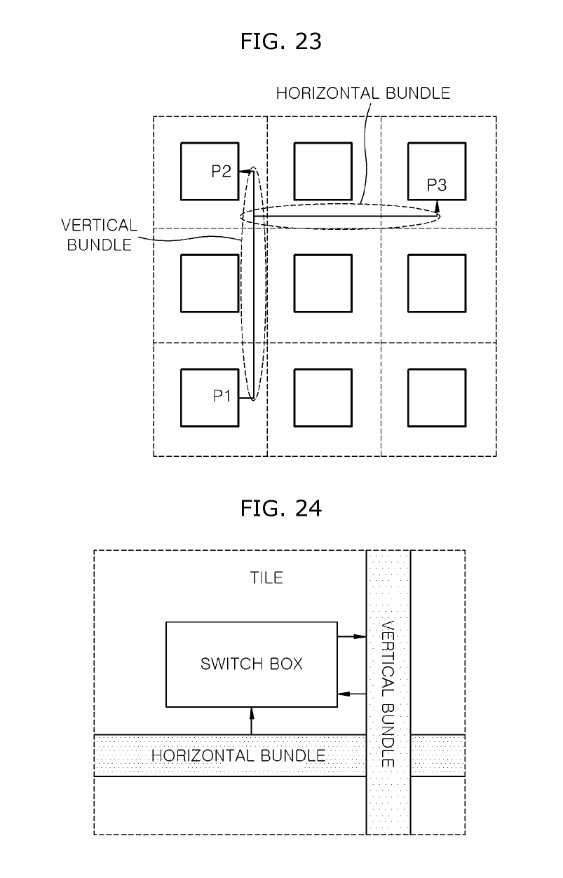

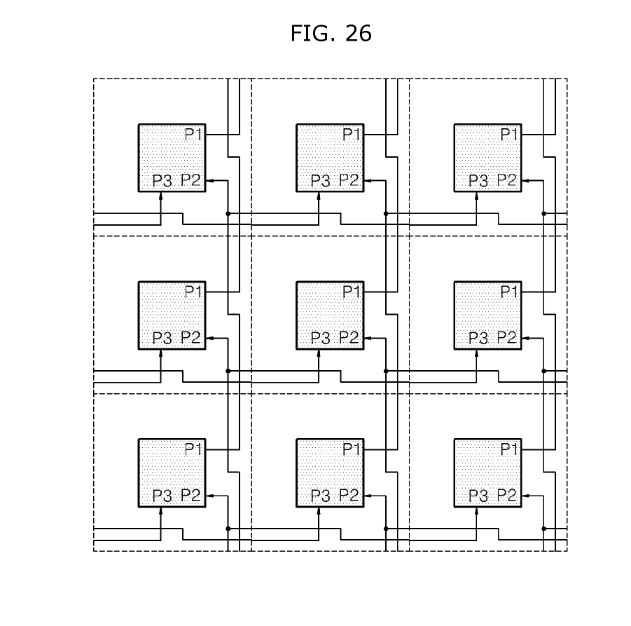

FIG. 23 illustrates two bundles extracted from the shortest path of the tile interconnection graph, and the two bundles are positioned as illustrated in FIG. 24 according to the type of vertexes forming the bundles. When the respective bundles of FIG. 24 are synthesized by the above-described method for synthesizing a simple bundle interconnection structure, a final tile interconnection structure is synthesized as illustrated in FIG. 25 at step S60. When the synthesized tile is arranged in a 3×3 array, it is possible to build an array-type interconnection structure as illustrated in FIG. 26.

The above-described process is repeated to synthesize the interconnection structure at step S70.

In accordance with the embodiment of the present invention, the coupling relation of the interconnection structure is received to construct the FPGA tile, and the FPGA tile is synthesized to automatically build the interconnection structure of the FPGA. Therefore, the FPGA tile including a complicated interconnection structure may be quickly designed at a logic level, and the interconnection structure of the FPGA is built as a schematic diagram, which makes it possible to facilitate the verification of the interconnection structure.

Furthermore, the interconnection structure at a logic level may be utilized to efficiently design the FPGA tile at a layout level. Accordingly, it is possible to significantly reduce the cost and time required for designing an FPGA board.

The embodiments of the present invention have been disclosed above for illustrative purposes. Those skilled in the art will appreciate that these various modifications, additions and substitutions are possible, without departing from the scope and spirit of the invention as disclosed in the accompanying claims.

What is claimed is:

1. A method for synthesizing a tile interconnection structure of a field programmable gate array (FPGA), comprising:
receiving an interconnection structure specification of the FPGA;
constructing a tile interconnection graph based on the interconnection structure specification;
converting the interconnection structure specification into a connection diagram between two points on the tile interconnection graph;
searching for a shortest path for connection requirements between two points from the connection diagram between two points, and building a bundle structure; and
synthesizing a tile interconnection structure from the bundle structure.

2. The method of claim 1, wherein the step of converting the interconnection structure specification comprises acquiring a minimum spanning tree from the connection requirements of the interconnection structure specification.

3. The method of claim 2, wherein the step of converting the interconnection structure specification comprises constructing a complete graph of the connection requirements of the interconnection structure specification, and
the minimum spanning tree is acquired from the complete graph.

4. The method of claim 1, wherein the tile interconnection graph is constructed by receiving the interconnection structure specification in a connection diagram form between ports.

5. The method of claim 1, further comprising determining whether the interconnection structure specification is a mixed bundle interconnection structure or not, before the constructing of the tile interconnection graph,
wherein when it is determined that the interconnection structure specification is a mixed bundle interconnection structure, the tile interconnection graph is constructed.

6. The method of claim 5, wherein the step of synthesizing the tile interconnection structure is performed by the unit of simple bundle interconnection structure.

7. The method of claim 1, wherein the tile interconnection graph comprises four ports disposed on respective surfaces of a switch box within each tile and four interconnection tracks connected to the four ports.
